(19) United States
(12) Patent Application Publication
(10) Pub. No.: US 2007/0057410 A1
(43) Pub. Date: Mar. 15, 2007

(54) Method of fabricating wafer chips

(75) Inventors: Dae-sang Chan, Asan-si (KR); Jun-young Ko, Cheonan-si (KR); Sang-jun Kim, Cheonan-si (KR); Wha-su Sin, Cheonan-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/500,345

(22) Filed: Aug. 8, 2006

(30) Foreign Application Priority Data
Aug. 9, 2005 (KR) 10-2005-0073001

(51) Int. Cl. H05B 6/00

(52) U.S. Cl. 264/482

(57) ABSTRACT

Example embodiments of the present invention relate to a method of packaging a semiconductor device. Other example embodiments of the present invention relate to a method of fabricating wafer chips for packaging a semiconductor device. Provided is a method of fabricating a wafer chips, which can perform a reliable pick-up process by removing the adhesive component adhering onto the cutting surfaces of the wafer chips, the diced DAF and the first base film. The method includes preparing at least one wafer, attaching at least one film onto a back surface of the wafer to support the wafer, forming wafer chips by dicing the wafer, detaching the at least one film from the wafer chips and attaching at least one base film onto the wafer chips to support the wafer chips.

### PRIORITY STATEMENT

This application claims priority under 35 U.S.C. § 119 to Korean Patent Application No. 10-2005-0073001, filed on Aug. 9, 2005, in the Korean Intellectual Property Office (KIPO), the entire contents of which are incorporated herein by reference.

### BACKGROUND

1. Field

Example embodiments of the present invention relate to a method of packaging a semiconductor device. Other example embodiments of the present invention relate to a method of fabricating wafer chips for packaging a semiconductor device.

2. Description of the Related Art

As electronic appliances continue to become smaller, efforts for reducing the thickness of semiconductor packages are being made. One of the methods of reducing the thickness of semiconductor packages is to lap the back surface of a wafer (e.g., a back lapping process). After performing the back lapping process, the wafer undergoes a dicing process to form wafer chips and the wafer chips are attached onto a substrate, for example, a lead frame and/or a printed circuit board and/or another wafer chip.

The wafer chip may be attached using resin or paste according to the conventional art. A resin bleed-out phenomenon (e.g., leakage of the applied resin or paste out of an attaching region of the wafer chip) may occur more frequently. The wafer chip may be attached onto the substrate with a height variation or may be attached at a slant on the substrate. Instead of applying resin or paste, attaching a die attach film (DAF) on the wafer chip has been suggested to solve the above problems.

FIGS. 1A-1D are diagrams for illustrating processes of fabricating a wafer chip using a DAF according to the conventional art. FIG. 1D is a diagram of the wafer chip taken along line d-d of FIG. 1C. Referring to FIG. 1A, a DAF 20a may be attached onto a back surface of a wafer 10a. Referring to FIG. 1B, a base film 30 including an attaching layer 31 and a base film layer 32 may be attached onto the DAF 20a. The base film 30 may further include a wafer ring 33 for handling the wafer 10a more easily. Referring to FIG. 1C, the wafer 10a and the DAF 20a may be diced into wafer chips (10b) attached by diced DAF (20b) in one piece, using a dicer 40 for a dicing process. Referring to FIG. 1D, a wafer chip 10b with the diced DAF 20b may be lifted by pressing a bottom surface of the base film 30 with pick-up needles 50 and the wafer chip 10b with the diced DAF 20b may be picked up by a vacuum pad 45 to separate the wafer chip 10b with the diced DAF 20b from the base film 30 during a pick up process.

FIGS. 2A and 2B are views illustrating problems of the conventional process of fabricating a wafer chip with a diced DAF. Referring to FIG. 2A, the wafer 10a and the DAF 20a may be cut simultaneously from the front surface of the wafer 10a through the DAF 20a and to some degree of thickness into the base film layer 32 of the base film 30 in the dicing process. The dicing process may be performed using a blade sawing method and/or a laser cutting method. During the dicing process, an adhesive component (a) included in the DAF 20a or in the attaching layer 31 of the base film 30 may be locally heated and melted along the cut line. The adhesive component (a) may then adhere to the cutting surface of the wafer 10a, the DAF 20a and the base film 30. As shown in FIG. 2B, edges of the wafer chip 10b may not be separated easily due to the adhesive component (a) during the pick-up process and a tensile stress may occur on the front surface of the wafer chips 10b due to warping of the wafer chip 10b.

Because the wafer chip undergoing the back lapping process is relatively thin (e.g., a thickness of about 50 μm˜about 80 μm), the tensile stress generated due to warping of the wafer chip 10b may induce cracks on the wafer chips 10b or degrade properties of an electronic device fabricated on the wafer chips 10b. Productiveness and reliability of electronic products may be degraded.

### SUMMARY

Example embodiments of the present invention relate to a method of packaging a semiconductor device. Other example embodiments of the present invention relate to a method of fabricating wafer chips for packaging a semiconductor device. Example embodiments of the present invention provide a method of fabricating a wafer chip, which may decrease tensile stress during a pick-up process by removing the adhesive component adhering onto the cutting surfaces of the wafer chips, the diced DAF and the first base film.

According to example embodiments of the present invention, there is provided a method of fabricating wafer chips, the method including preparing at least one wafer, attaching at least one film onto a back surface of the wafer to support the wafer, forming wafer chips by dicing the wafer, detaching the at least one film from the wafer chips and attaching at least one base film onto the wafer chips to support the wafer chips. The at least one film may be a first base film, a die attach film and/or both. The at least one base film may be a first base film or a second base film. The first base film and the second base film include an attaching layer and a base film layer. The step of forming wafer chips may be performed using a blade sawing method and/or a laser cutting method. The step of forming wafer chips may be performed by cutting the wafer all at once from a front surface of the wafer to the surface of the attaching layer of the first base film or to some degree of thickness into the base film layer.

The method may further include coupling a fixing unit for fixing the wafer chips to the front surface of the wafer chips, after the step of forming the wafer chips. The fixing unit may be a fixing film having an attaching layer attached to the front surface of the wafer chips and/or a vacuum chuck having a vacuum stage for absorbing the wafer chips. The step of detaching the first base film may be performed by pulling the first base film from the wafer chips at an angle within a range of about 90°˜about 180° between the first base film and an attaching/detaching surface of the wafer chip. The second base film may be the same as the first base film and/or a new base film. The attaching layer of the first base film and/or the second base film may be a photosensitive attaching layer which may lose its adhesive force by ultraviolet ray irradiation. The attaching layer of the first base film and/or the second base film may be a foaming attaching layer which may lose its adhesive force by heating. The method may further include attaching a die attach film (DAF) onto the back surface of the wafer before attaching the first base film, and dicing the DAF in one piece with the wafer. A DAF may be attached onto the attaching layer of the first base film and the DAF may be attached onto the back surface of the wafer with the first base film.

According to other example embodiments of the present invention, there is provided a method of fabricating a wafer chip including preparing a plurality of wafer chips, attaching a DAF and a first base film including an attaching layer and a base film layer onto back surfaces of the wafer chips to support the wafer chips, dicing the DAF in one piece with the wafer chips, detaching the first base film from the diced DAF and attaching a second base film including an attaching layer and a base film layer onto the diced DAF to support the wafer chips. The method may further include coupling a fixing unit for fixing the wafer chips to the front surface of the wafer chips, after the step of forming the wafer chips. The fixing unit may be a fixing film having an attaching layer attached to the front surface of the wafer chips and/or a vacuum chuck having a vacuum stage for absorbing the wafer chips.

The DAF and the first base film may be sequentially attached onto the wafer chips, or the DAF and the first base film may be attached simultaneously onto the wafer chips after being coupled to each other. The step of forming wafer chips may be performed using a blade sawing method and/or a laser cutting method. The step of forming wafer chips may be performed by cutting the wafer in one piece from a front surface of the wafer to the surface of the attaching layer of the first base film or to some degree of thickness into the base film layer. The step of detaching the first base film may be performed by pulling the first base film from the wafer chips at within a range of about 90°˜about 180° between the first base film and an attaching/detaching surface of the wafer chip.

According to still other example embodiments of the present invention, there is provided a method of fabricating a wafer chip including preparing a plurality of wafer chips, attaching a DAF onto back surfaces of the wafer chips, dicing the DAF in one piece with each of the wafer chips and attaching a first base film, including an attaching layer and a base film layer, onto the diced DAF to support the wafer chips. The step of dicing the DAF may be performed using a laser cutting method. The method may further include picking up the wafer chips attached with the diced DAF.

### BRIEF DESCRIPTION OF THE DRAWINGS

Example embodiments of the present invention will be more clearly understood from the following detailed description taken in conjunction with the accompanying drawings. FIGS. 1A-6B represent non-limiting, example embodiments of the present invention as described herein.

FIGS. 1A through 1D are diagrams for illustrating processes of fabricating a wafer chip using a conventional DAF;

FIGS. 2A and 2B are diagrams for illustrating problems of the processes of fabricating the wafer chip using the conventional DAF;

FIGS. 3A through 3F are diagrams for illustrating processes of fabricating a wafer chip according to example embodiments of the present invention;

FIGS. 4A through 4D are diagrams for illustrating processes of fabricating a wafer chip according to other example embodiments of the present invention;

FIGS. 5A through 5E are diagrams for illustrating processes of fabricating a wafer chip according to other example embodiments of the present invention; and

FIGS. 6A and 6B are diagrams for illustrating processes of fabricating a wafer chip according to other example embodiments of the present invention.

### DETAILED DESCRIPTION OF EXAMPLE EMBODIMENTS OF THE PRESENT INVENTION

Various example embodiments of the present invention are described more fully hereinafter with reference to the accompanying drawings, in which example embodiments of the present invention are shown. Example embodiments of the present invention may, however, be embodied in many different forms and should not be construed as limited to the example embodiments set forth herein. Rather, these embodiments are provided so that this disclosure will be thorough and complete, and will fully convey the scope of example embodiments of the present invention to those skilled in the art. In the drawings, the sizes and relative sizes of layers and regions may be exaggerated for clarity.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. A first element, component, region, layer or section discussed below could be termed a second element, component, region, layer or section without departing from the teachings of the example embodiments of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. The exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the example embodiments of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments of the present invention belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention relate to a method of packaging a semiconductor device. Other example embodiments of the present invention relate to a method of fabricating wafer chips for packaging a semiconductor device.

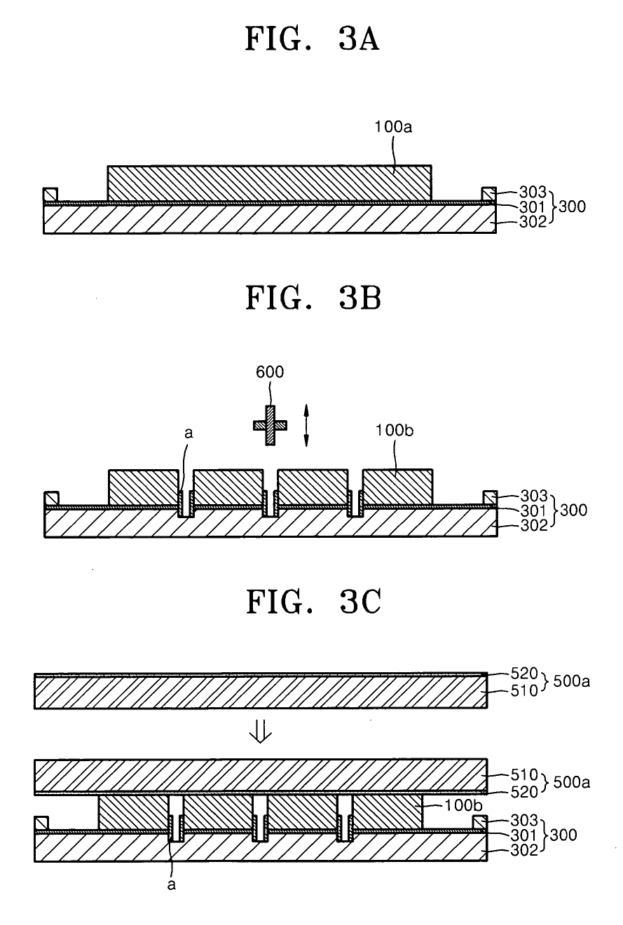

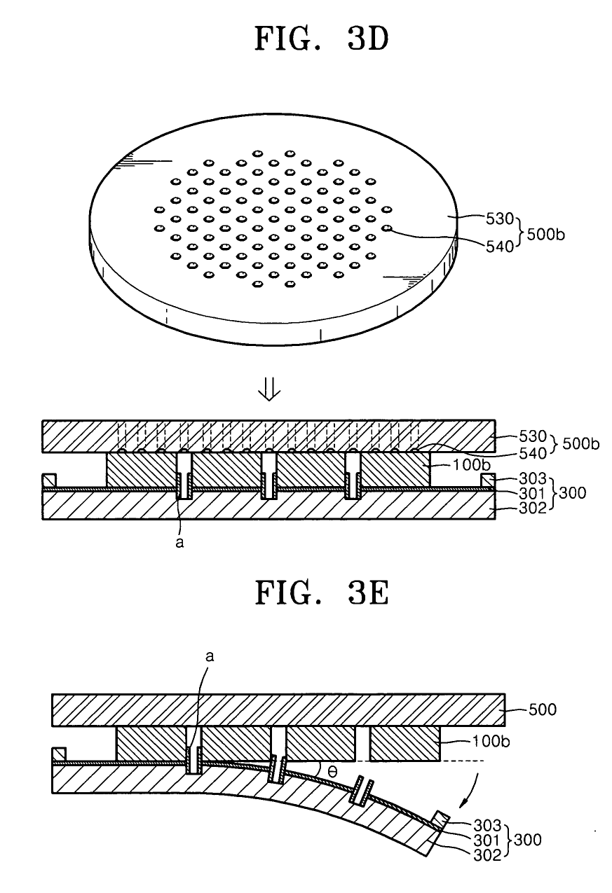

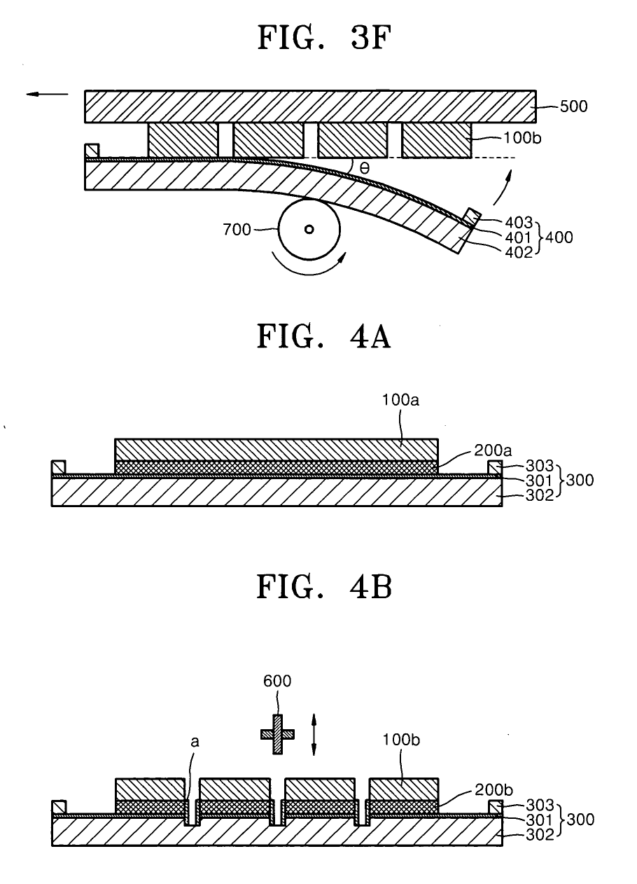

FIGS. 3A through 3F are diagrams illustrating processes of fabricating wafer chips according to example embodiments of the present invention. Referring to FIG. 3A, a first base film 300 including an attaching layer 301 and a base film layer 302 may be attached onto a back surface of a wafer 100a to support the wafer 100a. The first base film 300 may further include a wafer ring 303 on a circumference thereof for handling the wafer 100a more easily. The wafer 100a may have undergone a back lapping process. Referring to FIG. 3B, a dicing process may be performed using a dicer 600 (e.g., a blade or a laser to dice the wafer 100a into wafer chips 100b along sawing lines). The wafer 100a may be separated into the wafer chips 100b by sawing the wafer 100a from the front surface of the wafer 100a to the surface of the attaching layer 301 of the first base film 300 or to some degree of thickness into the base film layer 302 of the first base film 300. During the dicing process, an adhesive component (a) of the attaching layer of the first base film 300 may be locally heated and melted and may adhere to cutting surfaces of the first base film 300 and the wafer chips 100b.

Referring to FIGS. 3C and 3D, a fixing unit, e.g. fixing film 500a or vacuum chuck 500b for fixing the wafer chips 100b may be coupled to the front surface of the wafer chip 100b as a pre-process of detaching the first base film 300. The fixing film 500a having a fixing film layer 510 and an attaching layer 520 attached onto the wafer chips 100b The fixing film 500a may be a contamination prevention tape used in the back lapping process. A vacuum chuck 500b having a vacuum stage 530 that may absorb the wafer chips 100b may also be used as the fixing unit. The vacuum stage 530 may include flowing paths 540 for absorbing the wafer chips 100b.

Referring to FIG. 3E, after the dicing process, the first base film 300 may be detached from the wafer chip 100b fixed by the fixing unit 500a. For example, the first base film 300 may be detached from the wafer chip 100b by pulling the first base film 300 at an angle (θ) within a range of about 90°˜about 180° between the first base film 300 and an attaching/detaching surface of the wafer chip 100b. The force applied perpendicularly to an interface between the fixing unit 500a and 500b and the wafer chips 100b may be negligible and the wafer chips 100b may be more stably fixed onto the fixing unit 500a and 500b. The adhesive component (a) adhering to the surfaces of the wafer chips 100b may be removed with the detached first base film 300 by separating the adhesive component (a) from the cutting surfaces of the wafer chips 100b using a simple process of detaching the first base film 300 from the wafer chips 100b.

Referring to FIG. 3F, a second base film 400 including an attaching layer 401 and a base film layer 402 may be attached on the surfaces of the wafer chips 100b, in order to support the wafer chip 100b after separating the first base film 300 from the wafer chips 100b. The second base film 400 may further include a wafer ring 403 on a circumference thereof. The second base film 400 may be the same as the first base film 300 (refer to FIG. 3A˜3E) or the second base film 400 may be a new base film. The attachment of the second base film 400 may be performed using a general laminator including a taping unit (e.g., a roller 700). The attaching layers 301 and 401 of the first base film 300 and the second base film 400 may be photosensitive attaching layers which may lose their adhesive forces by ultraviolet ray irradiation and/or foaming attaching layers which may lose their adhesive forces by heating.

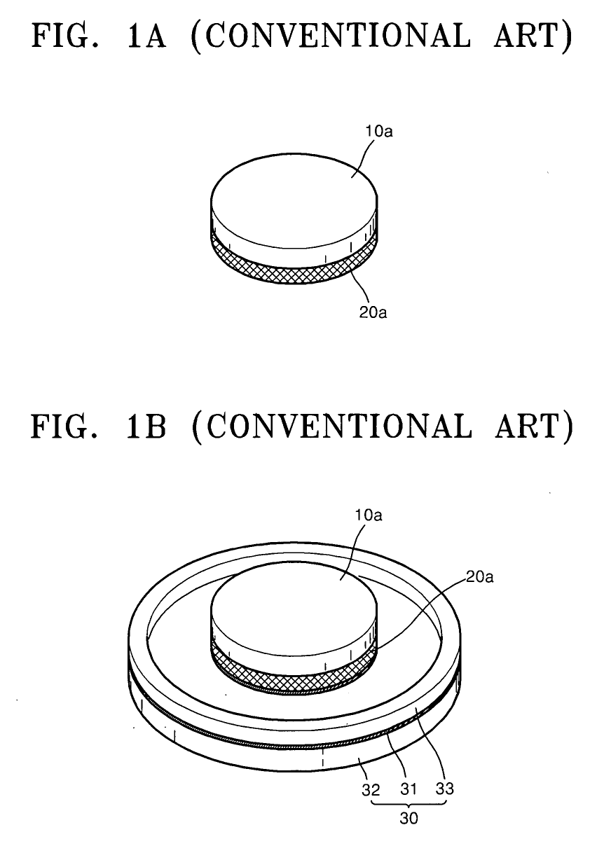

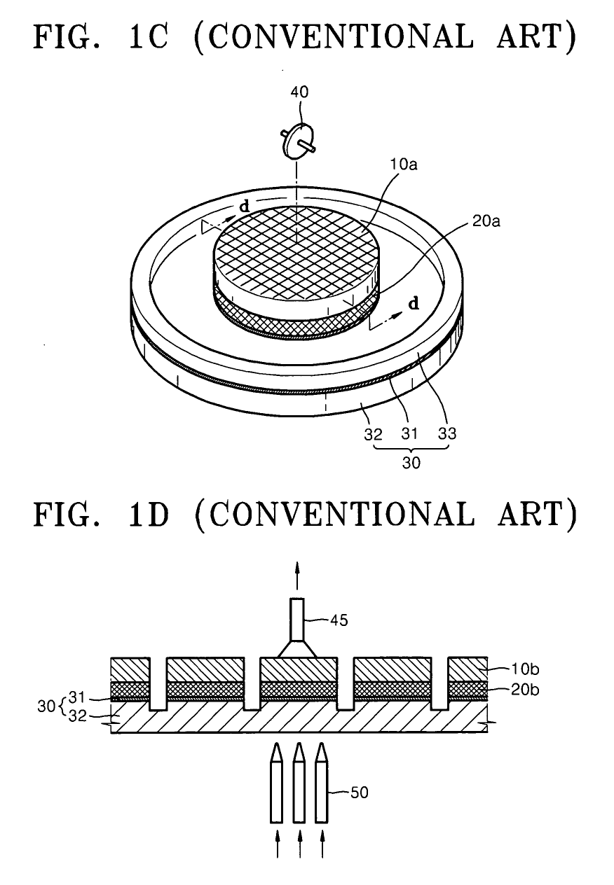

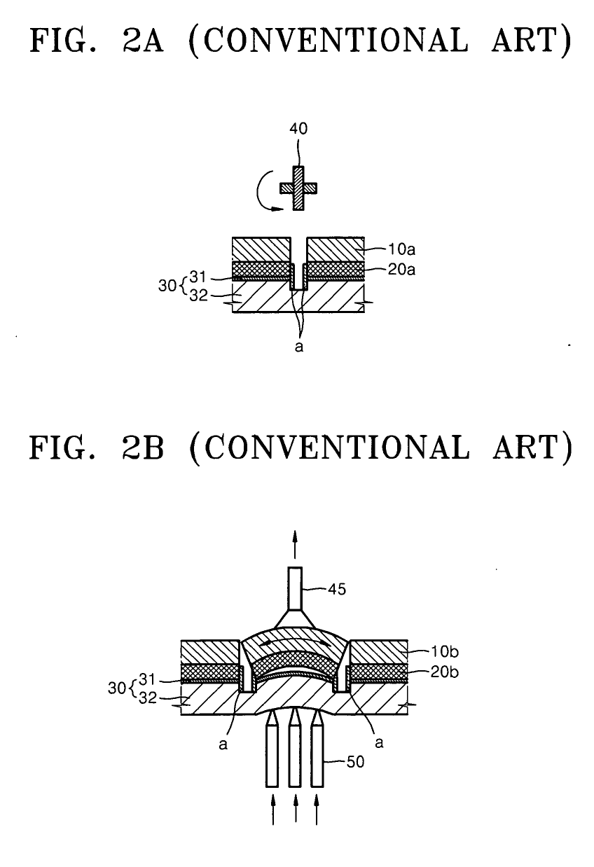

As shown in FIG. 1D, each of the wafer chips 100b may be lifted by pressing the bottom surface of the second base film 400 with a pick-up needle (not shown) and each of the wafer chips 100b may be picked up by a vacuum pad (not shown) to separate the wafer chip 100b from the second base film 400. A packaging process may be performed (e.g., a resin or a paste may be applied on the back surfaces of the wafer chips 100b to attach the wafer chips 100b to a substrate, for example, a lead frame or a printed circuit board or to another wafer chip). A DAF may also be applied to the wafer chips for packaging a semiconductor device, as in the following example embodiments of the present invention.

According to example embodiments of the present invention, the pick-up force may be determined by the adhesive force of the second base film 400 and the attaching area of the wafer chip 100b with the second base film 400 during the pick-up process of the wafer chips 100b. Example embodiments of the present invention may provide a more reliable pick-up process to retard or prevent warping of the wafer chips even if the wafer chips are relatively thin (e.g., a thickness of 50 μm˜80 μm) due to back lapping process,

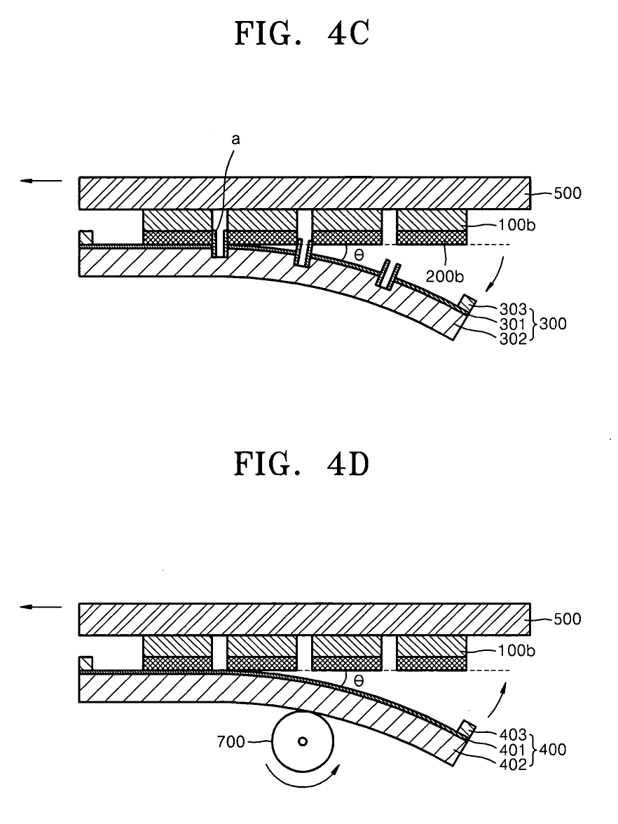

FIGS. 4A through 4D are diagrams illustrating processes of fabricating wafer chips according to other example embodiments of the present invention.

Referring to FIG. 4A, a DAF 200a may be attached on a back surface of a wafer 100a, as a coupling unit for attaching the wafer chip 100a onto a substrate or another wafer chip. The DAF 200a may be attached onto the back surface of the wafer 100a before attaching a first base film 300 onto the wafer 100a. The DAF 200a may also be attached onto an attaching layer 301 of the first base film 300 and may be attached onto the back surface of the wafer 100a simultaneously with the first base film 300. Referring to FIG. 4B, in a dicing process, the wafer 100a and the DAF 200a may be cut in one piece from the front surface of the wafer 100a through the DAF 200a and to some degree of thickness into the base film layer 302 of the first base film 300 in the dicing process. In the dicing process, the adhesive component (a) may be locally heated and melted and adhere onto the cutting surfaces of the wafer chips 100b, the diced DAF 200b and the first base film 300.

Referring to FIG. 4C, after the dicing process, the first base film 300 may be detached from the diced DAF 200b. As shown in FIG. 3E, the first base film 300 may be detached from the diced DAF 200b by pulling the first base film 300 at an angle (θ) within a range of about 90°˜about 180° between the first base film 300 and an attaching/detaching surface of the diced DAF 200b. Referring to FIG. 4D, the second base film 400 including the attaching layer 401 and the base film layer 402 may be attached on the surfaces of the wafer chips 100b with the diced DAF 200b in order to support the wafer chips 100b after detaching the first base film 300 from the wafer chips 100b. The second base film 400 may further include a wafer ring 403 on a circumference thereof. The second base film 400 may be the same as the first base film 300 (refer to FIG. 4C) or may be a new base film. As shown in FIG. 1D, each of the wafer chips 100b may be lifted by pressing the bottom surface of the second base film 400 with a pick-up needle (not shown) and each of the wafer chips 100b may be picked by a vacuum pad (not shown) to separate the wafer chip 100b from the second base film 400.

According to example embodiments of the present invention, the adhesive component adhering onto the cutting surfaces of the wafer chips 100b, the diced DAF 200b and the first base film 300 may be removed by a simple process (e.g., detaching the first base film 300 from the wafer chip 100b). Because the tensile stress on the wafer chips due to the adhesive component might not be generated during the pick-up process, the process yield of fabricating the wafer chips may be improved. Because the adhesive component that may interfere with the pick-up process may be removed, the pick-up force may be determined by the adhesive force between the DAF and the second base film and the attaching area of the diced DAF 200b with the second base film 400. The uniform pick-up force may provide a more reliable pick-up process for fabricating the wafer chips. The method of fabricating the wafer chips which may be sawed prior to a back lapping process as follows.

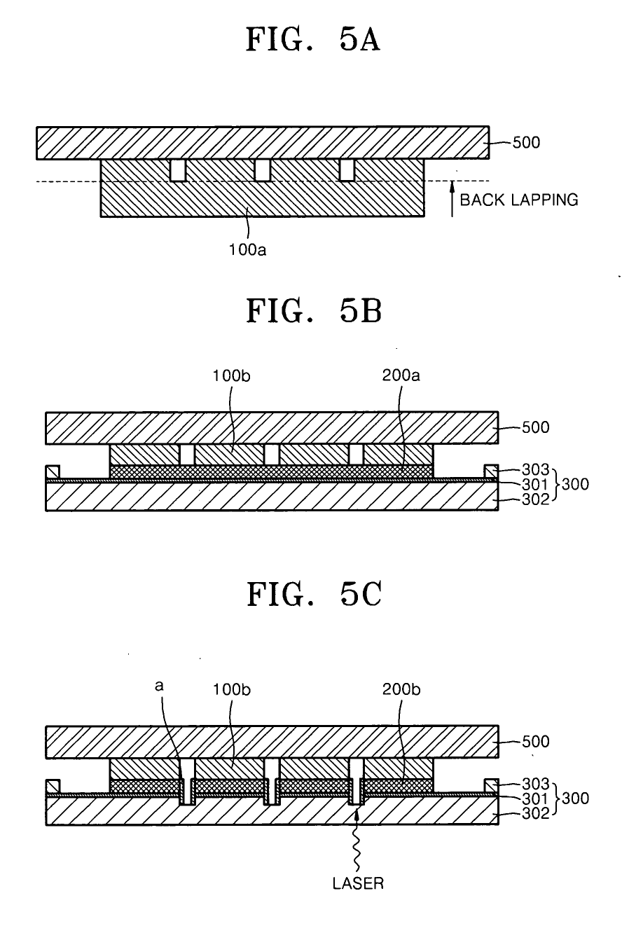

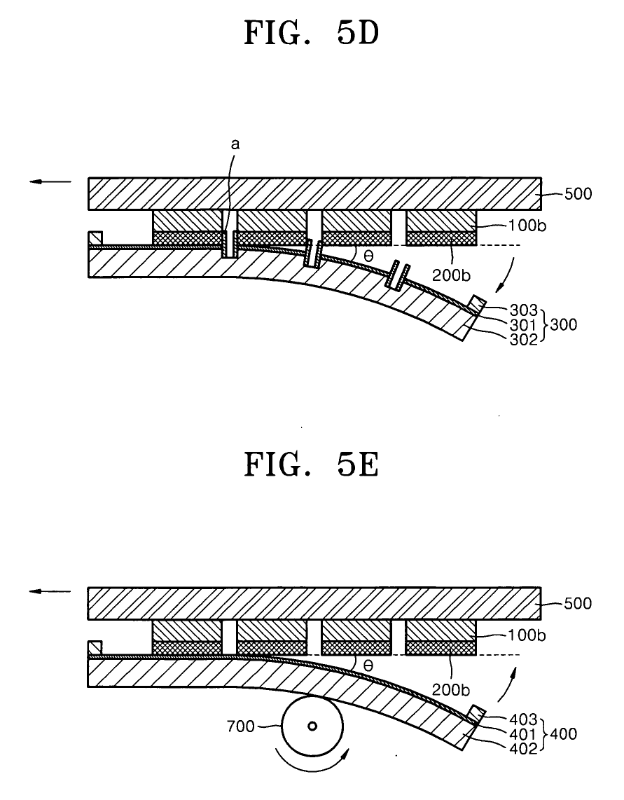

FIGS. 5A through 5E are diagrams illustrating processes of fabricating wafer chips according to other example embodiments of the present invention.

Referring to FIG. 5A, a wafer 100a may be sawed along the sawing lines to a given depth from the front surface of the wafer 100a. A fixing unit 500, for example, a contamination prevention tape, may be attached onto the front surface of the wafer 100a in order to fix the wafer chips 100b and retard or prevent the wafer 100a from being contaminated for consequent processes, for example, a back lapping process. The wafer 100a may be diced into wafer chips 100b by the back lapping process. Referring to FIG. 5B, a DAF 200a and a first base film 300 including an attaching layer 301 and a base film layer 302 for supporting the wafer chips 100b may be attached onto the back surfaces of the wafer chips 100b. The DAF 200a and the first base film 300 may be sequentially attached onto the back surfaces of the wafer chips 100b, or may be attached onto the back surfaces of the wafer chips 100b after being coupled to each other.

Referring to FIG. 5C, the DAF 200a may be cut into a diced DAF 200b in one piece with each of the wafer chips 100b using a laser cutting method. When dicing the DAF 200a, the adhesive component (a) included in the DAF 200b may be heated, melted and adhered onto the cutting surfaces of the first base film 300 and the diced DAF 200b. Referring to FIG. 5D, the first base film 300 may be detached from the diced DAF 200b to remove the adhesive component (a). Before detaching the first base film 300, the fixing unit 500 may be coupled to the front surfaces of the wafer chips 100b for fixing the wafer chips 100b. The fixing unit 500 may be, for example, the fixing film 500a or a vacuum chuck 500b as shown in FIGS. 3C and 3D.

Referring to FIG. 5E, a second base film 400 including an attaching layer 401 and a base film layer 402 may be attached onto the diced DAF 200b to support the wafer chips 100b. The second base film 400 may further include a wafer ring 403 on a circumference thereof. Referring to FIG. 1D, each of the wafer chips 100b may be lifted by pressing the bottom surface of the base film 400 using a pick-up needle (not shown) and each of the wafer chips 100b may be picked up using a vacuum pad (not shown) to separate the diced DAF 200b and the wafer chip 100b from the second base film 400.

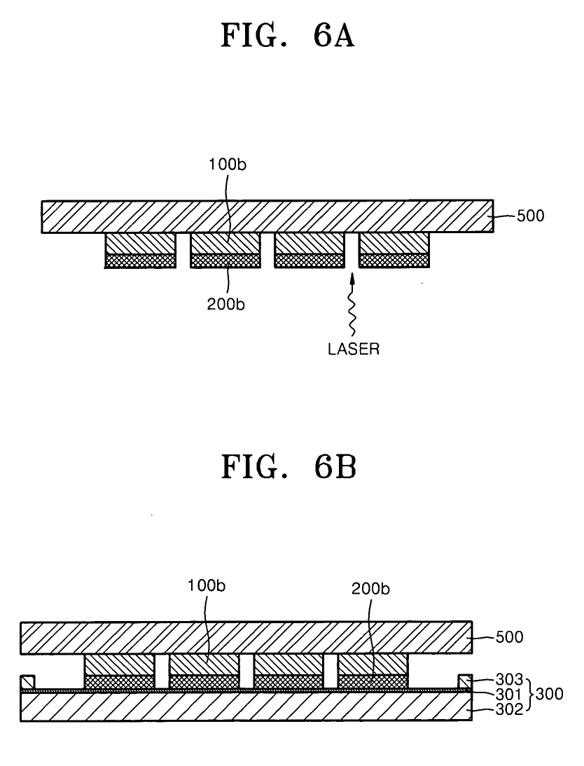

FIGS. 6A and 6B are diagrams illustrating processes of fabricating wafer chips according to other example embodiments of the present invention. Referring to FIG. 6A, after attaching a DAF 200b onto the back surfaces of wafer chips 100b, the DAF 200a may be diced into a diced DAF 200b in one piece with each of the wafer chips 100b. For example, the DAF 200a may be diced using a laser cutting method. Referring to FIG. 6B, a first base film 300 including an attaching layer 301 and a second base film layer 302 may be attached onto the diced DAF 200b to support the wafer chips 100b. The attaching layer 301 of the first base film 300 may be a photosensitive attaching layer which may lose its adhesive force by ultraviolet ray irradiation and/or a foaming attaching layer which may lose its adhesive force by heating.

Like the other example embodiments of the present invention described above, as shown in FIG. 1D, each of the wafer chips 100b may be lifted by pressing the bottom surface of the first base film 300 using a pick-up needle (not shown) and each wafer chip 100b may be picked up using a vacuum pad (not shown) to separate the wafer chip 100b and the diced DAF 200b from the first base film 300.

According to example embodiments of the present invention, because the first base film 300 is attached after performing the dicing process of the DAF in which the adhesive component of the DAF may be locally heated and melted, the adhesive component that may affect the pick-up process of the wafer chips 100b may not adhere on the first base film 300. The pick-up force of the wafer chip 100b may be determined by the adhesive force between the diced DAF 200b and the first base film 300 and the attaching area of the diced DAF 200b with the first base film 300 during the pick-up process. Example embodiments of the present invention may provide a more reliable pick-up process to retard or prevent warping of the wafer chips.

As mentioned above, according to example embodiments of the present invention, the adhesive component, adhering on the cutting surfaces of the wafer chips, the diced DAF and the first base film during the dicing process, may be removed by detaching the first film from the diced DAF. A tensile stress may not occur on the wafer chips 100b during the pick-up process due to the attachment of the second base film onto the wafer chips 100b. Because the pick-up force may be determined by the adhesive force between the diced DAF, the second base film and the attaching area of the diced DAF with the second base film, the uniform pick-up force may provide a more reliable pick-up process for fabricating the wafer chips.

While various example embodiments of the present invention have been particularly shown and described with reference to example embodiments thereof, it will be understood by those of ordinary skill in the art that various changes in form and details may be made therein without departing from the spirit and scope of the example embodiments of the present invention as defined by the following claims.

What is claimed is:

1. A method of fabricating wafer chips, the method comprising:
preparing at least one wafer;
attaching at least one film onto a back surface of the wafer to support the wafer;
forming wafer chips by dicing the wafer;
detaching the at least one film from the wafer chips; and
attaching at least one base film onto the wafer chips to support the wafer chips.

2. The method of claim 1, wherein the at least one film is a first base film.

3. The method of claim 1, wherein the at least one film is a die attach film (DAF).

4. The method of claim 1, wherein the at least one film is a die attach film and a first base film.

5. The method of claim 1, wherein the at least one base film is a first base film or a second base film.

6. The method of claim 5, wherein the first base film or the second base film includes an attaching layer and a base film layer.

7. The method of claim 1, wherein the step of forming wafer chips is performed using a blade sawing method or a laser cutting method.

8. The method of claim 6, wherein the step of forming wafer chips is performed by cutting the wafer in one piece from a front surface of the wafer to the surface of the attaching layer of the first base film or to some degree of thickness into the base film layer.

9. The method of claim 2, wherein the step of detaching the first base film may be performed by pulling the first base film from the wafer chips at an angle within a range of about 90°˜about 180° between the first base film and an attaching/detaching surface of the wafer chip.

10. The method of claim 5, wherein the second base film is the same as the first base film or a new base film.

11. The method of claim 6, wherein the attaching layer of the first base film or the second base film is a photosensitive attaching layer which can lose its adhesive force by ultraviolet ray irradiation.

12. The method of claim 6, wherein the attaching layer of the first base film or the second base film is a foaming attaching layer which can lose its adhesive force by heating.

13. The method of claim 1, further comprising:
attaching a die attach film (DAF) onto the back surface of the wafer before attaching a first base film; and
dicing the DAF in one piece with the wafer.

14. The method of claim 6, wherein a DAF is attached onto the attaching layer of the first base film and the DAF is attached onto the back surface of the wafer with the first base film.

15. The method of claim 1, further comprising:
coupling a fixing unit for fixing the wafer chips to the front surface of the wafer chips, after the step of forming the wafer chips.

16. The method of claim 15, wherein the fixing unit is a fixing film having an attaching layer attached to the front surface of the wafer chips or a vacuum chuck having a vacuum stage for absorbing the wafer chips.

17. The method of claim 1, further comprising:
picking the wafer chips up.

18. The method of claim 13, further comprising:
picking the wafer chips attached with a diced DAF up.

19. The method of claim 4, wherein the first base film is detached from a diced DAF.

20. The method of claim 4, wherein the DAF and the first base film are sequentially attached onto the wafer chips, or the DAF and the first base film are attached simultaneously onto the wafer chips after being coupled to each other.

21. The method of claim 13, wherein the step of dicing the DAF is performed using a laser cutting method.
